(19) United States
(12) Patent Application Publication
(10) Pub. No.: US 2011/0246754 A1
(43) Pub. Date: Oct. 6, 2011

(54) PERSONALIZING OPERATING ENVIRONMENT OF DATA PROCESSING DEVICE

(75) Inventor: Gunjan Porwal, Pune (IN)

(73) Assignee: NVIDIA CORPORATION, Santa Clara, CA (US)

(21) Appl. No.: 12/753,915

(22) Filed: Apr. 5, 2010

(51) Int. Cl. G06F 15/177

(52) U.S. Cl. 713/1

(57) ABSTRACT

A method includes sensing a data uniquely associated with an environment of a user of a data processing device through a sensor associated with the data processing device and/or the data processing device. The method also includes personalizing an operating environment of the data processing device based on the sensed data.

### FIELD OF TECHNOLOGY

This disclosure relates generally to data processing devices and, more particularly, to a method, an apparatus and/or a system of personalizing an operating environment of a data processing device.

### BACKGROUND

A data processing device (e.g., a mobile phone, a laptop computer, a notebook computer, a desktop computer) may be used in home/office environments under varying conditions including but not limited to brightness of light in the environment and silence in the environment. A user of the data processing device may have to appropriately configure the data processing device to suit the aforementioned environments and conditions.

For example, the user may have to manually increase a brightness of a monitor of a desktop computer when the brightness of the environment interferes with viewing of the monitor. In another example, the user may use a mobile phone at home after work hours at his/her office. Here, the user may opt to have different operating computing environments based on whether he/she is at the office or at home. When the user is at home, the user may have to manually change the operating computing environment (e.g., a home screen of the mobile phone) from an “office” computing environment (e.g., home screen of the mobile phone displaying office/work related icons) to a “home” computing environment (e.g., home screen of the mobile phone displaying personal icons).

The tedium involved in the abovementioned processes may lead to the user losing interest in modifying the operating environments of the data processing device, despite being inclined to do so.

### SUMMARY

Disclosed are a method, an apparatus and/or a system of personalizing an operating environment of a data processing device.

In one aspect, a method includes sensing a data uniquely associated with an environment of a user of a data processing device through a sensor associated with the data processing device and/or the data processing device. The method also includes personalizing an operating environment of the data processing device based on the sensed data.

In another aspect, a method includes storing a reference data uniquely associated with an environment of a user of a data processing device in a memory of the data processing device, and sensing a non-reference data uniquely associated with the environment of the user through a sensor associated with the data processing device and/or the data processing device. The method also includes personalizing an operating environment of the data processing device based on the sensed non-reference data and the reference data.

In yet another aspect, a data processing device includes an interface configured to be coupled to an external sensor and/or an internal sensor configured to enable sensing of a data uniquely associated with an environment of a user of the data processing device. The data processing device also includes a memory configured to store a reference data uniquely associated with the environment of the user and/or the sensed data, and a processor configured to compare the sensed data with the reference data to personalize the operating environment of the data processing device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of processing in the data processing device of FIG. 1 as a hierarchy of layers, according to one or more embodiments.

FIG. 3 is an example scenario of a mobile phone exemplifying the data processing device of FIG. 1 in an environment, according to one or more embodiments.

FIG. 4 is an example scenario of the mobile phone in a home environment, according to one or more embodiments.

FIG. 5 is a home screen view of the mobile phone illustrating a one-time user storing of a reference data, according to one or more embodiments.

FIG. 6 is a process flow diagram detailing the operations involved in the personalization of an operating environment of a data processing device, according to one or more embodiments.

FIG. 7 is a process flow diagram detailing the operations involved in the personalization of an operating environment of a data processing device based on a sensed data and a reference data, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of personalizing an operating environment of a data processing device. Although the present embodiments have been described with reference to specific example embodiments, it will be evident that various modifications and changes may be made to these embodiments without departing from the broader spirit and scope of the various embodiments.

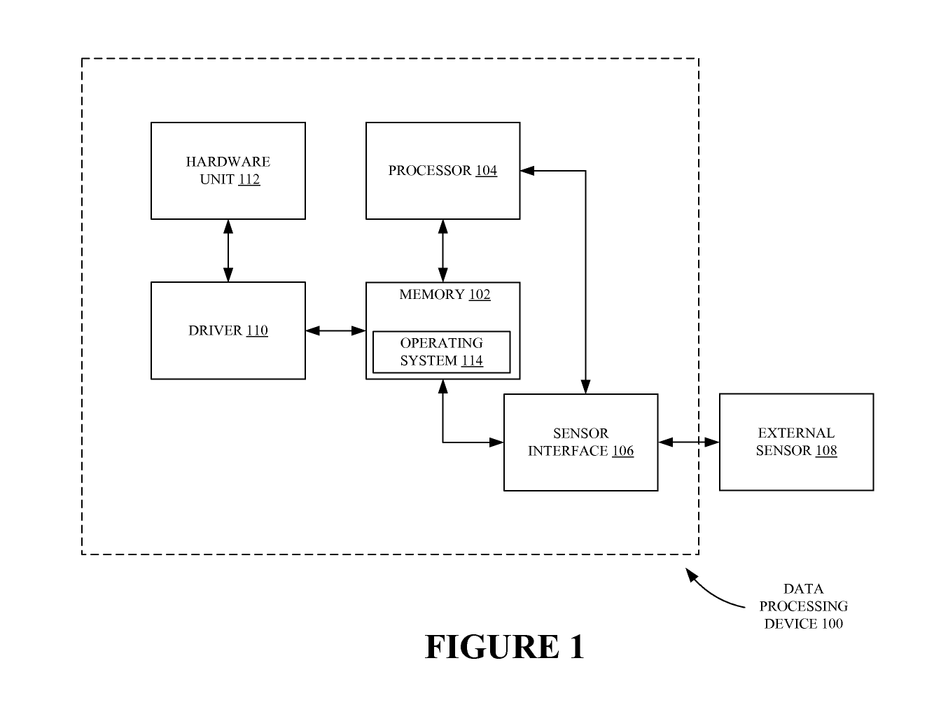

FIG. 1 shows a data processing device 100, according to one or more embodiments. In one or more embodiments, data processing device 100 may include a sensor interface 106 configured to be coupled to an external sensor 108. In one or more embodiments, external sensor 108 may be configured to sense a data uniquely associated with an environment of a user of data processing device 100. For example, the environment may be an office environment, a home environment, a workplace environment, an operating environment, a proximate environment, an external environment, an internal environment, a surrounding environment, and/or a proximate environment. In one or more embodiments, the sensed data may be configured to be input to data processing device 100 through sensor interface 106. In one or more embodiments, data processing device 100 may also include an internal sensor (not shown) configured to sense the data uniquely associated with the environment of the user.

In one or more embodiments, data processing device 100 may be a portable device such as a mobile phone, a laptop computer, and a notebook computer or a desktop computer. In an example embodiment, external sensor 108 may be an image sensor inside a digital camera configured to be coupled to data processing device 100 through sensor interface 106. In another example embodiment, the internal sensor may sense time at the location of the user of data processing device 100. In yet another example embodiment, the internal sensor may be a camera in data processing device 100. The purposes of the aforementioned sensing will be discussed below in detail. More examples of data sensed that may be uniquely associated with the environment of the user include but are not limited to an image data, a video data, a text data, an audio data, a temperature data, a brightness data, a speed data, a positional data, a date data, and a time data.

In one or more embodiments, during operation of data processing device 100, data may first be sensed through sensor interface 106 (or, through the internal sensor) and stored in a memory 102 of data processing device 100 as a reference for subsequently sensed data. In one or more embodiments, memory 102 may include a non-volatile memory (e.g., Read-Only Memory (ROM), hard-disk) and/or a volatile memory (e.g., Random-Access Memory (RAM)). In one or more embodiments, memory 102 may also include an operating system 114 (e.g., Android™, Linux™, Microsoft®'s Windows™) of data processing device 100 resident therein. In one or more embodiments, the reference data may be transferred to data processing device 100 through an external device (e.g., Universal Serial Bus (USB) flash drive, a Compact Disk (CD), another data processing device). In one or more embodiments, data processing device 100 may include an appropriate interface therefor.

In one or more embodiments, subsequently sensed data may be subjected to a comparison with the stored reference data using a processor 104. In one or more embodiments, processor 104 may include a Central Processing Unit (CPU) and/or a Graphics Processing Unit (GPU). In one or more embodiments, a pattern matching algorithm may be utilized for the aforementioned comparison process. In one or more embodiments, the instructions associated with the pattern matching algorithm may be stored in memory 102. In one or more embodiments, based on the match between the stored reference data and the subsequently sensed data, an operating environment of data processing device 100 may be modified. In one or more embodiments, memory 102 may be part of processor 104.

In one or more embodiments, the new sensed data and/or the reference data may be communicated to processor 104 configured to perform the pattern matching process. In one or more embodiments, based on the pattern matching, a request associated with the personalization of the operating environment of data processing device 100 may be communicated to operating system 114. In one or more embodiments, the interaction between operating system 114 and a requisite hardware (e.g., hardware unit 112) of data processing device 100 may be governed by a driver 110. In one or more embodiments, operating system 114 may communicate a system call to hardware unit 112 to be modified in accordance with the request. For example, circuits associated with hardware unit 112 may then be switched off appropriately to personalize the operating environment of the user. Examples of hardware units 112 include but are not limited to a computer monitor, a mobile phone display, and even processor 104 of data processing device 100. Examples of operating environments include but are not limited to home screen icons of data processing device 100, brightness of the home screen, audio volume of data processing device 100, and processor 104 speed.

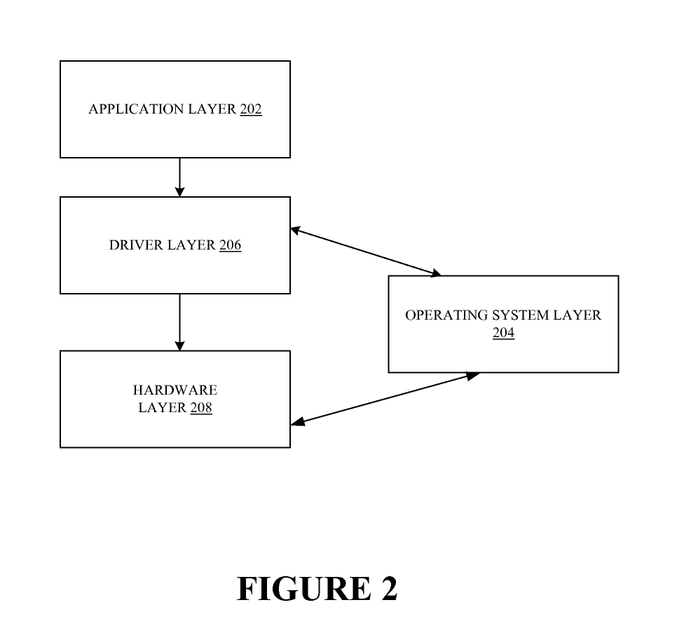

FIG. 2 shows processing in data processing device 100 as a hierarchy of layers, according to one or more embodiments. In one or more embodiments, the topmost layer may be application layer 202 where the applications (e.g., camera applications, audio applications) reside. In one or more embodiments, operating system layer 204 may include shared libraries that exist to aid services provided by operating system 114 to be utilized by the applications at application layer 202. In one or more embodiments, driver layer 206 may be configured to handle the interaction between operating system layer 204 and hardware layer 208. In one or more embodiments, driver layer 206 may be associated with drivers 110 unique to operating system 114 and hardware units 112. In one or more embodiments, hardware layer 208 may include devices (e.g., hardware units 112) required to support the other layers. In one or more embodiments, an application at application layer 202 may interact with a driver 110 at driver layer 206, following which driver 110 may communicate a system call associated with the interaction to operating system 114 at operating system layer 204. In one or more embodiments, both driver layer 206 and hardware layer 208 may interact with operating system layer 204, as shown in FIG. 2.

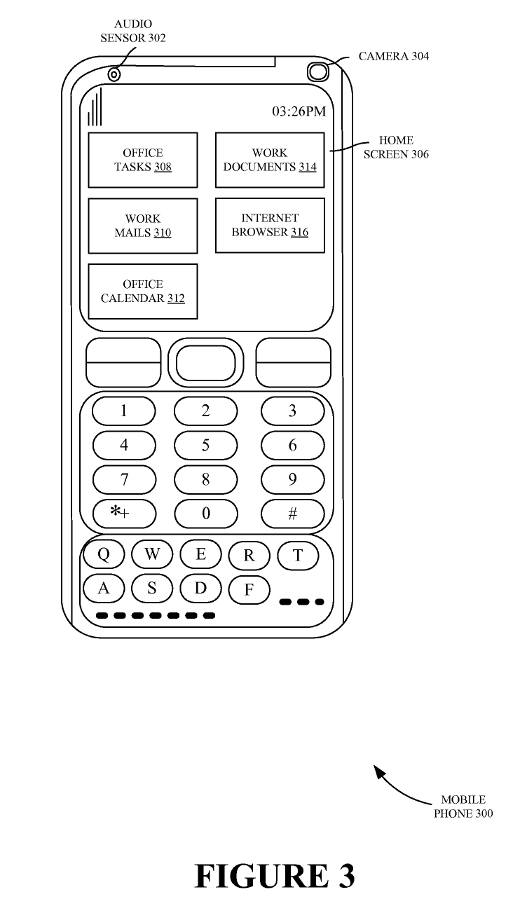

FIG. 3 shows an example scenario of a mobile phone 300 in an office environment, according to one or more embodiments. In the example embodiment of FIG. 3, a mobile phone 300 is data processing device 100, and audio sensor 304 and camera 302 are the internal sensors provided therein. It is obvious that external sensors 108 may be utilized for the purposes discussed below. Also, camera 302 and audio sensor 304 are chosen as exemplary sensors merely for purposes of illustration.

When a user of mobile phone 300 is in his/her office, camera 302 may be configured to capture images of the office environment (e.g., office walls with pictures, cubicle walls with citations), and audio sensor 304 may be configured to capture a voice data associated with the office environment (e.g., voice of the boss, voice of co-worker). Either camera 302 or audio sensor 304 may be configured to operate at a time. In an example embodiment, both camera 302 and audio sensor 304 may operate at the same time. In another example embodiment, an external digital camera (not shown) may be configured to be coupled to mobile phone 300 as external sensor 108.

The images of the office environment and/or the voice of the boss may be stored in a memory (e.g., memory 102) of mobile phone 300 as references. The user may provide the aforementioned reference images and/or the requisite reference voice data through an external device. In another example embodiment, camera 302 and/or audio sensor 304 may be activated, and the user may be provided an option to store the aforementioned reference images and/or the reference voice data in the memory (e.g., memory 102) of the mobile phone 300 after capturing the images and/or the voice data through the appropriate sensors.

When the user arrives at his/her office, camera 302 and/or audio sensor 304, when activated, may be configured to capture images and/or voice data of the environment (e.g. office) associated with the user. For example, camera 302 may be a video camera configured to include video information of the environment associated with the user as video frames. In another example, camera 302 may be configured to capture pictures of the environment associated with the user periodically. In yet another example, audio sensor 304 may be configured to detect voice data in the environment associated with the user. Once the pattern matching algorithm utilized by the processor (e.g., processor 104) of mobile device 300 detects a match between the newly detected image data/voice data (e.g., wall pictures of office, voice of boss) and the stored reference image data/voice data (e.g., reference wall pictures of office, reference voice of boss), the home screen 306 of mobile phone 300 may switch from the current operating environment (e.g., a home screen having icons indicating personal use) to an “office” operating environment (e.g., home screen 306 having icons indicating official use).

As shown in FIG. 3, icons associated with the “office” operating environment may include folders/icons such as office tasks 308, work mails 310, official calendar 312, work documents 314, and Internet browser 316. Assuming that the user drives back home from his/her office following the end of work, camera 302 may detect the vehicle (e.g., car) of the user through pictures thereof, and the present operating environment (e.g., home screen 306 having icons indicating official use) may be switched to a “driving” operating environment (e.g., home screen 306 having icons indicating driving/navigation such as Maps, Global Positioning System (GPS), Traffic Updates, and Voice Dial). Here, reference pictures of the “driving” operating environment may, again, be stored in the memory (e.g., memory 102) of mobile phone 300 in advance. Other ways to detect that the user is driving include but are not limited to utilizing data from the accelerometer of the vehicle through mobile phone 300 to recognize the speed of the user and utilizing a mobile phone 300 with in-built GPS/navigational capabilities.

When the user arrives home, camera 304 may, for example, detect pictures associated therewith, and home screen 306 of mobile phone 300 may be switched to a “home” operating environment (e.g., home screen 306 having personal icons). Alternately, audio sensor 302 may detect the voice of the spouse of the user or the child of the user, following which home screen 306 of mobile phone 300 may be switched to the “home” operating environment. Again, as described above, reference data associated with “home” pictures and/or “home” voice may be stored in mobile phone 300 in advance.

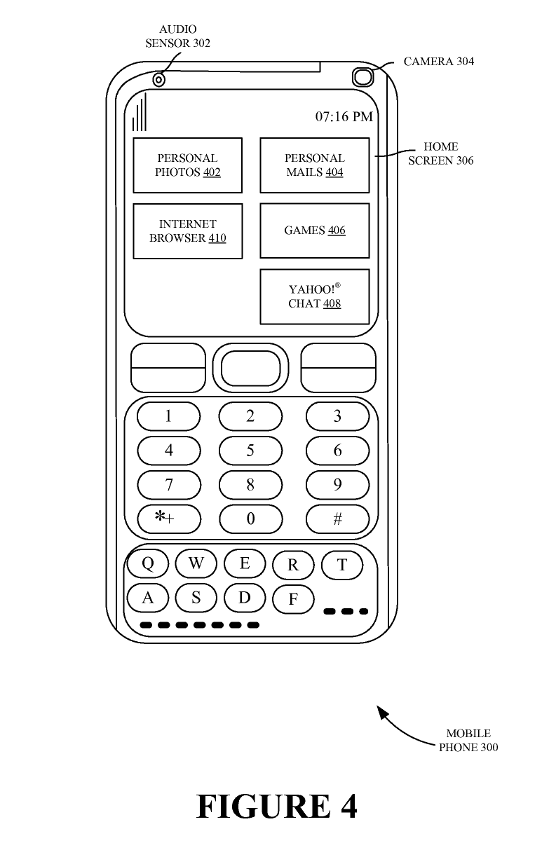

FIG. 4 shows an example scenario of mobile phone 300 in the home environment, according to one or more embodiments. Here, as discussed above, home screen 306 shows icons/folders such as personal photos 402, personal mails 404, games 406, Yahoo!® chat 408, and Internet browser 410. Internet browser 410 (analogous to Internet browser 316) may be a common icon to the “home” operating environment and the “office” operating environment. However, certain aspects such as bookmarks and the customized homepage may be modified during the switching between the two operating environments.

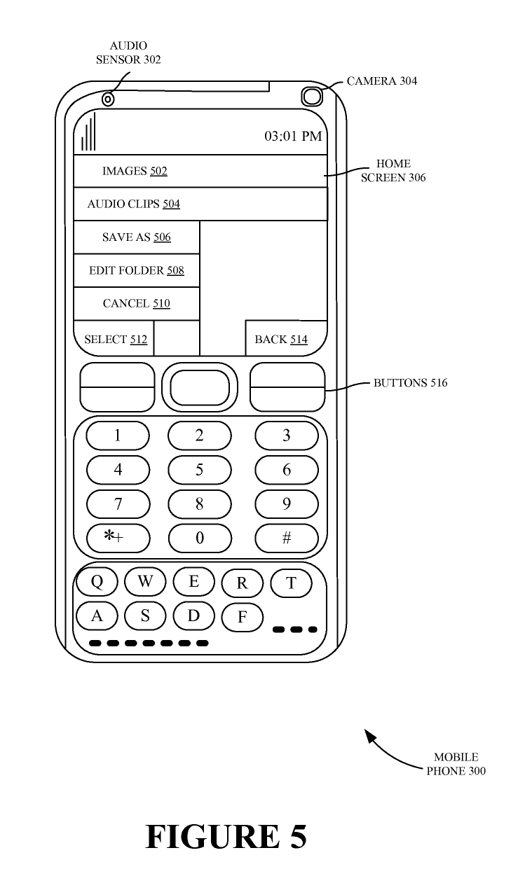

In one or more embodiments, the reference data (e.g., pictures of office, voice of spouse) may need to be stored in data processing device 100 (e.g., mobile phone 300) during a one-time set-up. FIG. 5 is a home screen 306 view of mobile phone 300 illustrating the one-time user storing of the reference data, according to one or more embodiments. The home screen 306 may be provided by the operating system (e.g., operating system 114) inside mobile phone 300. The user may capture an office image using camera 304 (ideally located at the back of mobile phone 300) and store the image in the Images 502 folder. The options available to the user may include “Save As” 506, “Edit Folder” 508 and “Cancel” 510. Selecting of options and/or folders/icons through “Select” 512 may be possible through a touch-screen capability of the display of mobile phone 300 or through buttons 516 provided therein. “Save As” may enable labeled storage of the office image file in a corresponding folder (e.g., Images 502 folder). For example, the voice of the spouse of the user may be stored in Audio Clips 504 folder. “Edit Folder” 508 may enable editing the location of the image file/audio clip. “Cancel” 510 may enable cancelation of the current task. “Back” 514 may enable returning to the previous state of home screen 306.

Once the reference data is stored, camera 304/audio sensor 302 may be activated for subsequent sensing of data. If new image/audio data is sensed through mobile phone 300, pattern matching may be implemented utilizing the processor (e.g., processor 104) and the memory (e.g., memory 102) of mobile phone 300 to detect a match between the sensed data and the stored reference data. When a match is detected, home screen 306 settings associated with the reference data may automatically be applied to home screen 306. During storing of the reference data, an audible alert tone may also be registered therewith.

In scenarios such as the office of the user being newly painted, the reference data may not be valid therefrom. When the processor (e.g., processor 104) is unable to detect a match between the stored reference data and the newly sensed data, a prompt may be generated, whereby the user may capture new images of the office to be stored in mobile phone 300.

As discussed above, in one or more embodiments, data uniquely associated with the external environment of the user may be sensed utilizing data processing device 100. The abovementioned embodiments of FIGS. 3-5 serve merely as examples, and other scenarios involving personalization of operating environments of data processing devices 100 based on data uniquely associated with the environments of users thereof are well within the scope of the exemplary embodiments. For example, brightness of a computer monitor may be modified to suit user requirements based on the brightness of the environment. In another example, the user may set a time frame for office hours as a reference data. The data processing device 100 (e.g., desktop computer, laptop computer) may utilize the system clock therein to personalize the operating environment (e.g., desktop screen).

In one or more embodiments, a number of personalization requirements may be combined to provide a number of personalized operating environments to the user. For example, the user may arrive from the office and immediately use mobile phone 300 in a low brightness environment at home. The brightness of mobile phone 300 display may be dynamically modified appropriately based on the sensed data uniquely associated with the environment of the user, along with the home screen 306 switching to indicate a “home” operating environment with the associated icons. In another example, a number of personalized operating environments may be combined to effect the personalized operating environment of mobile phone 300 when the user is driving. Here, the resulting personalized environment may include a loud audio alert with vibration, backlight of mobile phone 300 configured to be in an “ON” state, and home screen 306 configured to provide the abovementioned driving related icons.

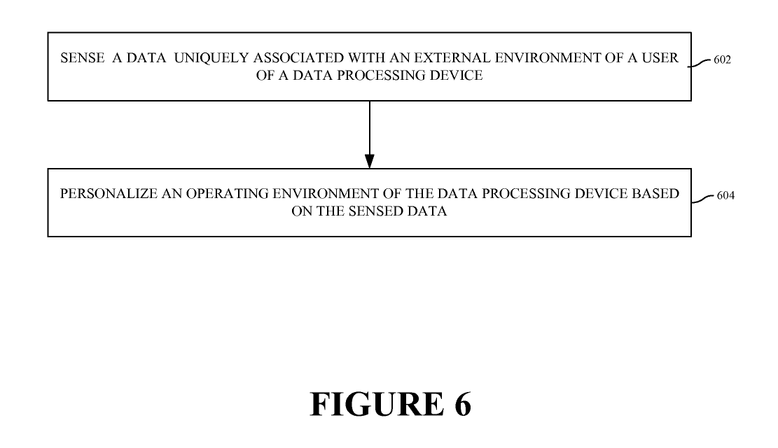

FIG. 6 shows a process flow diagram detailing the operations involved in a method of personalizing an operating environment of a data processing device 100, according to one or more embodiments. In one or more embodiments, operation 602 may involve sensing a data uniquely associated with an environment of a user of data processing device 100 through a sensor associated with data processing device 100 and/or data processing device 100. In one or more embodiments, operation 604 may involve personalizing the operating environment of data processing device 100 based on the sensed data.

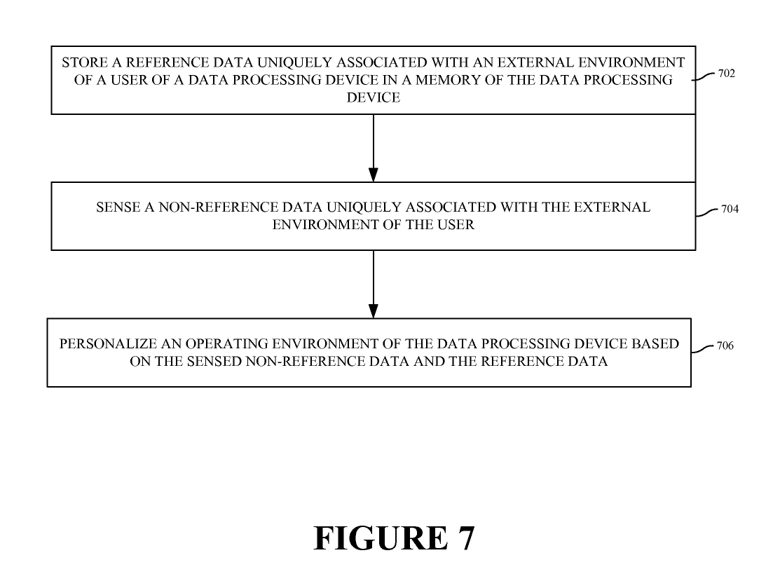

FIG. 7 shows a process flow diagram detailing the operations involved in a method of a personalizing an operating environment of a data processing device 100 based on a sensed data and a reference data, according to one or more embodiments. In one or more embodiments, operation 702 may include storing the reference data uniquely associated with an environment of a user of data processing device 100 in a memory 102 of data processing device 100. In one or more embodiments, operation 704 may include sensing a non-reference data uniquely associated with the environment of the user through a sensor associated with data processing device 100 and/or data processing device 100. In one or more embodiments, operation 706 may then involve personalizing an operating environment of data processing device 100 based on the sensed non-reference data and the reference data.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Accordingly, the specification and drawings are to be regarded in an illustrative rather than a restrictive sense.

What is claimed is:

1. A method comprising:
sensing a data uniquely associated with an environment of a user of a data processing device through at least one of a sensor associated with the data processing device and the data processing device; and
personalizing an operating environment of the data processing device based on the sensed data.

2. The method of claim 1, further comprising:
storing the sensed data in a memory of the data processing device as a reference data uniquely associated with the environment of the user of the data processing device; and
comparing a new sensed data, uniquely associated with the environment of the user of the data processing device and sensed through the at least one of the sensor associated with the data processing device and the data processing device, with the reference data to personalize the operating environment of the data processing device.

3. The method of claim 1, further comprising personalizing the operating environment of the data processing device as an effect of a plurality of personalized operating environments of the data processing device,
wherein each personalized operating environment of the plurality of personalized operating environments is based on the sensed data.

4. The method of claim 1, further comprising:
transferring a reference data uniquely associated with the environment of the user of the data processing device from an external device to the data processing device; and
comparing the sensed data through the at least one of the sensor associated with the data processing device and the data processing device with the reference data to personalize the operating environment of the data processing device.

5. The method of claim 2, wherein at least one of the new sensed data and the reference data is at least one of an image data, a video data, a text data, an audio data, a temperature data, a brightness data, a speed data, a positional data, a date data, and a time data.

6. The method of claim 2, wherein personalizing the operating environment of the data processing device comprises modifying the operating environment of the data processing device based on the comparison of the new sensed data with the reference data.

7. The method of claim 2, further comprising:
communicating at least one of the new sensed data and the reference data to a processor in the data processing device;
communicating a request associated with the personalization of the operating environment of the data processing device from the processor to an operating system associated therewith; and
interacting between the operating system and a requisite hardware of the data processing device through a driver to effect the personalization of the operating environment of the data processing device in accordance with the request.

8. The method of claim 7, utilizing a pattern matching algorithm through the processor and the memory to compare the new sensed data with the reference data.

9. A method comprising:
storing a reference data uniquely associated with an environment of a user of a data processing device in a memory of the data processing device;
sensing a non-reference data uniquely associated with the environment of the user through at least one of a sensor associated with the data processing device and the data processing device; and
personalizing an operating environment of the data processing device based on the sensed non-reference data and the reference data.

10. The method of claim 9, wherein personalizing the operating environment of the data processing device based on the sensed non-reference data and the reference data comprises modifying the operating environment of the data processing device based on a comparison of the sensed non-reference data with the reference data.

11. The method of claim 9, wherein at least one of the reference data and the non-reference data is at least one of an image data, a video data, a text data, an audio data, a temperature data, a brightness data, a speed data, a positional data, a date data, and a time data.

12. The method of claim 9, further comprising:
communicating at least one of the sensed non-reference data and the reference data to a processor in the data processing device;
communicating a request associated with the personalization of the operating environment of the data processing device from the processor to an operating system associated therewith; and
interacting between the operating system and a requisite hardware of the data processing device through a driver to effect the personalization of the operating environment of the data processing device in accordance with the request.

13. The method of claim 9, further comprising personalizing the operating environment of the data processing device as an effect of a plurality of personalized operating environments of the data processing device,
wherein each personalized operating environment of the plurality of personalized operating environments is based on the sensed non-reference data and the reference data.

14. The method of claim 9, further comprising transferring the reference data from an external device to the data processing device.

15. The method of claim 9, further comprising sensing the reference data through the at least one of the sensor associated with the data processing device and the data processing device.

16. The method of claim 12, utilizing a pattern matching algorithm through the processor and the memory to compare the sensed non-reference data with the reference data.

17. A data processing device comprising:
at least one of an interface configured to be coupled to an external sensor and an internal sensor configured to enable sensing of a data uniquely associated with an environment of a user of the data processing device;
a memory configured to store at least one of a reference data uniquely associated with the environment of the user and the sensed data; and
a processor configured to compare the sensed data with the reference data to personalize the operating environment of the data processing device.

18. The data processing device of claim 17, wherein at least one of the reference data and the sensed data is at least one of an image data, a video data, a text data, an audio data, a temperature data, a brightness data, a speed data, a positional data, a date data, and a time data.

19. The data processing device of claim 17, wherein the memory includes at least one of a non-volatile memory and a volatile memory.

20. The data processing device of claim 17,
wherein the processor is at least one of a Central Processing Unit (CPU) and a Graphics Processing Unit (GPU); and
wherein the data processing device is one of a mobile phone, a laptop computer, a notebook computer, and a desktop computer.
